(19) United States
(12) Patent Application Publication
(10) Pub. No.: US 2009/0158830 A1
(43) Pub. Date: Jun. 25, 2009

(54) ARTIFICIAL NEURAL NETWORK ENHANCED MISFIRE DETECTION SYSTEM

(76) Inventors: Gerard W. Malaczynski, Bloomfield Hills, MI (US); Stephen Levijoki, Swartz Creek, MI (US); David B. Miller, Brighton, MI (US)

Correspondence Address: DELPHI TECHNOLOGIES, INC., M/C 480-410-202, PO BOX 5052, TROY, MI, 48007, US

(21) Appl. No.: 11/961,139

(22) Filed: Dec. 20, 2007

(51) Int. Cl. G01M 15/11

(52) U.S. Cl. 73/114.04

(57) ABSTRACT

A system and method for misfire detection in a multi-cylinder internal combustion engine system includes an engine-speed activated artificial neural network (ANN)-based detection function. An input vector includes a plurality of engine speed derivatives attributable to a respective cylinder, and also includes engine speed and load values. The input vector values are updated each combustion cycle. A conventional misfire detection block is used when the engine speed is at or below an engine speed threshold. An ANN-based misfire detection block is used when the engine speed exceeds the threshold. The ANN-based block is configured to emulate a plurality of distinct ANNs each of which is conditioned by a respective set of weights and biases to correspond to and detect when a respective cylinder has misfired. The ANN-based block includes an output signal for each ANN indicating whether the respective cylinder has misfired.

### TECHNICAL FIELD

The present invention relates generally to misfire detection in an internal combustion engine, and more particularly to an artificial neural network (ANN)-enhanced misfire detection system.

### BACKGROUND OF THE INVENTION

A misfire condition in an internal combustion engine results from either a lack of combustion of the air/fuel mixture, sometimes called a total misfire, or an instability during combustion, sometimes referred to as a partial misfire. In such case, torque production attributable to the misfiring cylinder decreases. Additionally, un-combusted fuel enters the exhaust system, which is undesirable. Because of the possible impact on the ability to meet certain emission requirements, engine misfire detection is needed.

Misfire detection is desired across the full speed and load operating region of a vehicle. Production algorithms have been developed and employed successfully on four and six cylinder engines since the mid-1990s. In this regard, one strategy evaluates speed variations (or derivatives thereof). Misfire may thus be detected through monitoring, over a full combustion cycle, variations in the instant engine speed (or its derivatives). Typically, a time sample is acquired once per combustion event, i.e., a number of time samples creating a base for further calculations of angular speed and its derivatives being equal to the number of cylinders. This approach limits the angular resolution of any parameter proposed to represent an engine speed variation that could possibly be due to a misfire. In addition, as a result of limited sampling resolution defined by the engine controller clock frequency, and machining error of a flywheel, the algorithm's ability to discriminate between normal and firing events is limited.

First, low load and high engine speed make detectability more difficult since, due to the system's inertia, the underlying misfire disturbance will have less impact on the driven mechanical system. Second, increasing the inertia of the driveline and lowering the cylinder contribution, as which occurs with higher-number-of-cylinder engines, also compromises detectability. Engine mechanical resonance at certain combinations of speed and/or loads can also complicate detection. Finally, variations between different engines and their corresponding target wheels that are used in producing the crankshaft-originated speed signal also complicates detection.

The conventional misfire detection algorithm described above typically produces a misfire flag if one or more of the engine speed derivatives exceed a predefined threshold level. As the number of combustion events per unit time increase, either due to higher engine speed and/or more cylinders, both normal and misfire events produce a response under the conventional algorithm that is ever closer to the threshold level. These responses, at even-higher engine speeds, may start to overlap. Thus, the conventional algorithm's outcome under these conditions becomes unreliable.

One alternative proposed in the art to improve misfire detection employs a pattern recognition technique. Specifically, it is known to use artificial neural network (ANN) hardware to detect misfire in an automobile. However, dedicated ANN hardware can be costly and is dedicated to the specific application, which limits flexibility and makes the operating characteristics difficult to change.

There is therefore a need for a system and method for detecting misfire that minimizes or eliminates one or more of the problems as set forth above.

### SUMMARY OF THE INVENTION

The invention is directed to a system and method for detecting misfire in a multi-cylinder internal combustion engine system. The misfire detection system includes an engine-speed activated artificial neural network (ANN)-based detection service. One advantage of the present invention is that it more reliably indicates whether misfire has occurred in higher-number-cylinder engines (e.g., six-cylinder, eight-cylinder, etc.), at higher engine speeds, at lighter engine loads and combinations thereof, and under other conditions where conventional speed-variation type approaches do not reliably indicate misfire. In one embodiment, the functionality of an ANN hardware can be emulated with a microprocessor-coded algorithm, which would be comprised of a number of subroutines equal to the number of cylinders.

A method for misfire detection includes a number of steps. The first step involves producing an input vector that includes a respective engine speed derivative for (and attributable to) each cylinder. In a preferred embodiment, the input vector further includes, in addition to the engine speed derivatives, engine speed and load values. The input vector is preferably updated once per combustion cycle. The next step of the method involves providing the input vector to a first artificial neural network (ANN)-based misfire detection functional block configured to operate in accordance with an ANN (i.e., via microprocessor emulation of the real ANN hardware). The ANN is associated with a selected one of the cylinders. The first misfire detection block has a first output signal, preferably originating from the ANN, indicative of whether the selected one cylinder has misfired. The final step involves generating, when an engine speed exceeds a predetermined threshold, a misfire signal for the engine system based on the first output signal from the ANN-based misfire detection block.

In a preferred embodiment, a conventional misfire detection block may be used when the engine speed is at or below an engine speed threshold, with the ANN-based misfire detection block being used only when the engine speed exceeds the threshold. In this preferred embodiment, the ANN-based misfire detection block is configured to operate in accordance with a plurality of distinct ANNs, each of which is conditioned by a respective set of weights and biases to correspond to and detect when a respective cylinder has misfired. The ANN-based misfire detection block has an output signal from each ANN indicating whether the respective cylinder has misfired. An engine speed controlled selector is configured to select from the output of either the low-speed, conventional misfire detection block or the inventive high-speed ANN-based misfire detection block based on whether the engine speed threshold is exceeded. Other features, objects and advantages of the present invention will be described in greater detail herein.

A corresponding system is also presented.

### BRIEF DESCRIPTION OF THE DRAWINGS

The present invention will now be described by way of example, with reference to the accompanying drawings.

FIG. 1 is a simplified diagrammatic and block diagram view of an internal combustion engine system having misfire detection according to the present invention.

FIG. 2 is a simplified diagrammatic and block diagram view showing, in greater detail, misfire detection having artificial neural network (ANN) functionality.

FIG. 3 is a simplified block diagram showing, in greater detail, a first embodiment of the ANN of FIG. 2.

FIG. 4 is a simplified block diagram showing, in greater detail, a second embodiment of the ANN of FIG. 2.

FIG. 5 is a simplified schematic and block diagram showing an arrangement for training the ANN embodiments of FIGS. 3-4.

### DETAILED DESCRIPTION OF THE PREFERRED EMBODIMENT

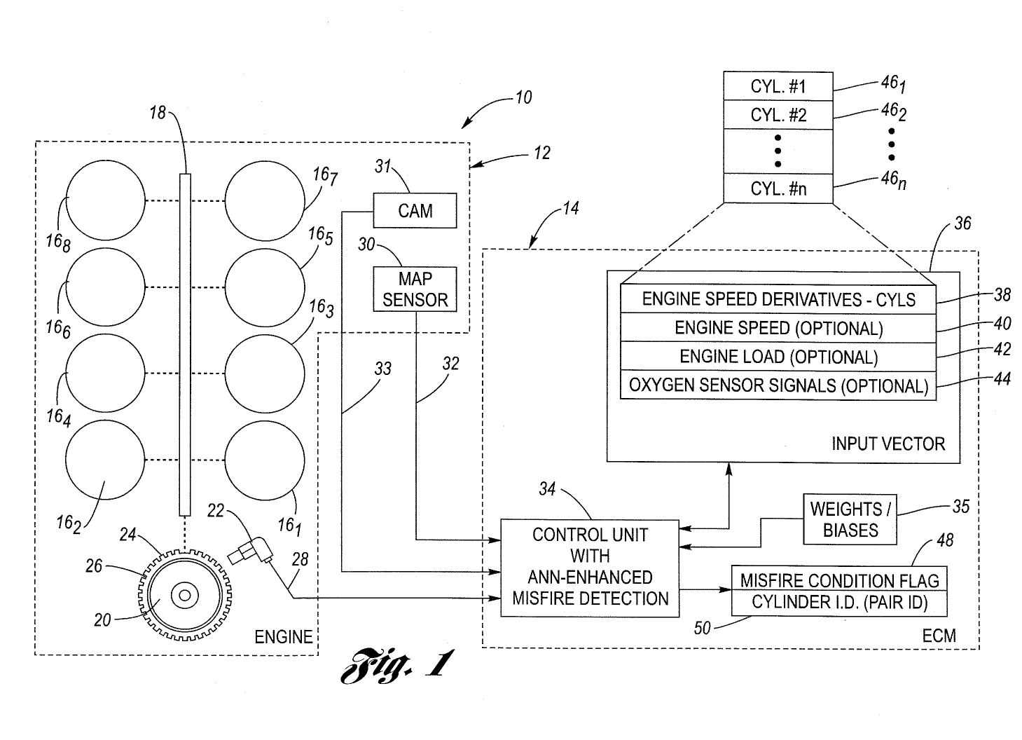

Referring now to the drawings wherein like reference numerals are used to identify identical components in the various views, FIG. 1 shows an internal combustion engine system 10 including an internal combustion engine 12 whose operation is controlled by a programmed, electronic engine control module (ECM) 14 or the like, as known generally in the art. System 10 is configured, as will be described and illustrated hereinafter, to provide improved misfire detection as to either an individual cylinder or multiple cylinder (e.g., a cylinder pair). System 10 includes improved discrimination capability that provides for more effective detection for higher-number-of-cylinder engines as well as over greater engine speed/load ranges.

An advantageous option for improvement to existing misfire detection approaches, without either changing the sampling rate and/or resolution, involves the use of a pattern recognition technique, specifically an artificial neural network (ANN). According to the present invention, an ANN-enhanced misfire detection strategy involves activating the use of the ANN, as described in greater detail below, at engine speeds known to cause difficulties in conventional detection algorithms (i.e., difficulty in producing reliable misfire detection results).

As described briefly in the Background, one of the shortcomings of the existing art is its inability to discriminate between normal operation and misfire. Table 1 below shows the typical performance of the existing art for an exemplary 8-cylinder engine.

TABLE 1

| Single cylinder misfire | | | Opposite pairs misfire | | |
|---|---|---|---|---|---|
| MAP | RPM | | MAP | RPM | |
| (load) | (speed) | DMSS | (load) | (speed) | DMSS |
| 30 | 3500 | >6 | 35 | 3500 | 2.46 |
| 35 | 4000 | >6 | 40 | 4000 | 1.26 |
| 50 | 4000 | >6 | 50 | 4000 | 1.94 |
| 35 | 4500 | >6 | 40 | 4500 | 0.49 |
| 50 | 4500 | >6 | 50 | 4500 | 1.09 |
| 40 | 5000 | >6 | 45 | 5000 | 0.25 |
| 45 | 5500 | 5.87 | 60 | 5500 | 0.50 |
| 60 | 5500 | >6 | 80 | 5500 | 1.17 |

The ability to discriminate between normal operation and misfires may be measured by calculating the statistical separation distance of a key indicative parameter (e.g., angular engine speed derivative(s)). The separation, DMSS, is defined as a difference between means divided by the summation of standard deviations. At relatively high engine speeds, especially when two opposite cylinders misfire, the existing art algorithm delivers poor performance. This is due to the fact that at high engine speeds, the inertia overshadows the engine vibrations, while misfire on consecutive halves of the combustion cycle precludes differentiating normal firing sequences from misfires. In short, a technique that is based on the comparison of normal and abnormal events fails. However, one may expect that the engine speed derivatives pattern, representing a full set of cylinders over one combustion cycle, remain different, and an abnormality should surface when the data are scrutinized by a pattern recognition technique, rather than discriminated against a pre-defined threshold level, in accordance with the invention.

With continued reference to FIG. 1, the engine 12 includes a plurality of cylinders, illustrated in exemplary fashion as a V-type, 8 cylinder engine where the cylinders are designated 16₁, 16₂, 16₃, . . . 16₈. In one arrangement, for example, the firing order may be designated as cylinders 1-8-7-2-6-5-4-3. Of course, other numbering schemes and/or firing orders are possible, as known in the art. Moreover, the present invention is not limited to any particular number of cylinders, i.e., an eight cylinder engine as shown is exemplary only, and may be, for example, a six-cylinder engine.

The basic arrangement of the engine 12 is known in the art, and will not be repeated exhaustively herein in detail. However, it should be understood that each cylinder 16₁, 16₂, 16₃, . . . 16₈ is equipped with a corresponding piston (not shown), which is connected to a common crankshaft 18, as shown by the dashed-line in FIG. 1. As known, the crankshaft 18 is coupled to a power-train (e.g., transmission and other drive-train components—not shown) in order to provide power to a vehicle (not shown) for movement. Controlled firing of the cylinders causes the various pistons to reciprocate in their respective cylinders, causing the crankshaft to rotate. There is a known relationship between the angular position of the crankshaft 18, and each of the pistons. Each piston, as it reciprocates, moves through various positions in its cylinder, and any particular position is typically expressed as a crankshaft angle with respect to top-dead-center position. In the well-known 4 stroke engine (intake-compression-power-exhaust), two full revolutions (720 degrees) of the crankshaft 18 occur to complete one engine cycle.

In this regard, FIG. 1 further shows a target wheel 20 and a corresponding sensor 22. Target wheel 20 is configured for rotation with crankshaft 18. Target wheel 20 includes a plurality of radially-outwardly projecting teeth 24 separated by intervening slots 26. Target wheel 20 and sensor 22 are, in combination, configured to provided an output signal 28 that is indicative of the angular position of crankshaft 18. Output signal 28 may be used to derive a speed indicative signal (and derivatives thereof).

In recent years, a commonly employed target wheel is one variant known as a 58× target wheel (i.e., 60−2; 58 teeth spaced around the wheel, spaced as though there were 60 evenly spaced teeth but with two teeth missing). In the illustrated embodiment, target wheel 20 may be the 58× form target wheel known in the art. This form of a target wheel 20 provides a rising edge in the output signal every 6 degrees, with the exception of the 2 tooth gap, which as known is used as a reference. A speed-based signal, for example, can be formed by determining the speed, or a representative signal, every 6 degrees or multiples of 6 degrees as typically only one edge is used. Existing misfire algorithms, however, typically acquire a time sample only once per combustion event, which in the case of an 8 cylinder engine translates to time sampling of the target wheel every 90 degrees.

FIG. 1 further shows an engine load indicative sensor such as an intake manifold absolute pressure (MAP) sensor 30. FIG. 1 further shows a camshaft position sensor (CAM) 31. The MAP sensor 30 is configured to produce an output signal 32 indicative of manifold absolute pressure. The output signal 32 is indicative of engine load. It should be understood that other signals may be used as a proxy for load, including but not limited to a mass air flow (MAF) signal or a throttle position signal. The CAM sensor 31 is configured to generate a CAM signal 33 that is indicative of which rotation of the engine cycle the crankshaft is on. That is, the crankshaft sensor output signal 28 alone is insufficient to determine whether the crankshaft is on the first 360 degree rotation or on the second 360 degree rotation, which would together define an engine cycle for a four-stroke engine.

With continued reference to FIG. 1, ECM 14 may include a control unit 34 with an ANN-enhanced misfire detection function. The ECM 14 may be characterized by general computing capability, memory storage, input/output (interface) capabilities and the like, all as known in the art. ECM 14 is configured generally to receive a plurality of input signals representing various operating parameters associated with engine 12, with three such inputs being shown, namely, crankshaft sensor output signal 28, MAP output signal 32 and CAM signal 33. ECM 14 is configured with various control strategies for producing needed output signals, such as fuel delivery control signals (for fuel injectors—not shown), all in order to control the combustion events, as well as spark timing signals (for respective spark plugs—not shown). In this regard, ECM 14 may be programmed in accordance with conventional, known air/fuel control strategies and spark timing strategies.

The ANN-enhanced misfire detection strategy uses existing misfire detection algorithms when the engine speed is equal to or less than a predetermined, threshold engine speed, while above this predetermined threshold, an ANN-based algorithm is activated. In a preferred embodiment, the control unit 34 is configured to operate as though it contained a plurality of distinct ANNs where each such ANN is arranged to service (i.e., determine normal operation or misfire) a corresponding cylinder in the engine (i.e., the number of emulated ANNs being equal to the number of cylinders). Each ANN is emulated in software and each is specifically conditioned in accordance with a respective set of weights/biases for its cylinder, as would be understood by one of ordinary skill in the art. The multiple sets of weights/biases 35 are shown in single block form, although it should be understood that each emulated ANN has its own set. Preferably, the values for the sets of weights/biases (i.e., one set for each ANN emulated) are initially obtained through a training process, which is described in greater detail in connection with FIG. 5. The training process is contemplated to occur in a calibration phase for the specific engine in advance of mass production. The weights/biases once established, are predetermined data as to the control unit 34 in mass production. That is, it is not presently contemplated as preferred that the training would occur during real-time operation of the engine system 10. However, further advancement in the speed of automotive service-oriented microprocessors and digital processing techniques may allow for the additional learning activity (i.e., extra subroutines) that would produce in-service correction of the calibration code to meet change in engine behavior associated with its aging process. The ANN-based algorithm therefore represents the collective action of multiple artificial neural networks (ANNs) respectively, specially tailored for a specific cylinder in the engine 12. The architecture of providing multiple ANNs for the multiple cylinders comes from the observation that each cylinder's response to a normal combustion event, or misfire as they case may be, is different due to its position and interaction with the rest of the mechanical system (e.g., crankshaft, fly wheel, location of bearings, etc.).

With continued reference to FIG. 1, an input vector 36 shown in block form is provided to all of the ANNs. The input vector 36 includes engine speed derivatives block 38, an optional instant engine speed (rpm) block 40, an optional engine load block 42 and one or more optional oxygen sensor signals block 44. The engine speed derivatives block 38 preferably comprises an array of values 46₁, 46₂, . . . 46ₙ representing an engine speed derivative associated with a respective one of the cylinders. For example, value 46₁ is associated with cylinder #1, value 46₂ is associated with cylinder 2, and so on with value 46ₙ being associated with the last cylinder #n, where n is the total number of cylinders in the engine. In this regard, what is contemplated by this invention is that each of the engine speed derivative values 46₁, 46₂, . . . 46ₙ reflect the engine speed variation (or derivative thereof) attributable to that cylinder. Thus, while the engine (e.g., crankshaft) will experience a normal, expected amount of acceleration for a normal combustion event in a particular cylinder, the engine, conversely, will experience an abnormal, unexpected deceleration when a partial or total misfire occurs in that cylinder. In one embodiment, the engine speed derivatives 46₁, 46₂, . . . 46ₙ comprise a respective engine speed variation attributable to that cylinder (i.e., either firing or misfiring). In a preferred embodiment, however, the engine speed derivatives 46₁, 46₂, . . . 46ₙ may comprise an acceleration value attributable to that cylinder. It is well known how to determine variations in engine speed (and derivatives thereof), particularly contribution attributed to each cylinder, using various information received from crankshaft position sensor 22 and camshaft position sensor 31.

The instant engine speed parameter shown in block 40, while optional, is desirable to be included in the input vector 36. The instant engine speed parameter 40 may be a time-averaged value over some portion on all of the engine cycle. It is well known how to determine this value from the raw data input from sensor 22. It should be further understood that the instant engine speed parameter 40 may be suitably scaled to fit the framework of the ANN-based algorithm implemented in the control unit 34. The instant engine load parameter shown in block 42, while optional, is also desirable to be included in the input vector 36. It is well known how to determine an engine load parameter using the MAP signal 32. It should be further understood that the instant engine load parameter 42 may be suitably scaled to fit the framework of the ANN-based algorithm implemented in the control unit 34. Finally, the input vector 36 may be arranged, optionally, to include one or more values directly or derived from one or more exhaust gas oxygen sensor outputs (e.g., switching, wide-band, etc.—not shown). For example, in a common configuration, one exhaust oxygen sensor is disposed in each one of first and second exhaust banks. It is known that a misfire on one cylinder would affect the output signal from the oxygen sensor which measures the corresponding exhaust gas bank. Notwithstanding the foregoing, based on current technology, the exhaust oxygen sensors as inputs work best at lower engine speeds-speeds at which existing art misfire detection approaches provide adequate performance.

Preferably, the constituent values of the input vector 36 are updated once each combustion event. It should be noted that the input vector 36, the same input vector 36, is provided to each of the multiple, uniquely-conditioned ANNs emulated by control unit 34. Thus, while each ANN for each cylinder can be different, due to being conditioned with unique weights/biases, each ANN will nonetheless receive the same input data, namely, the input vector 36.

With continued reference to FIG. 1, each of the multiple ANNs produce a respective output indicating whether that cylinder misfired (e.g., logic “1” flag) or fired normally (e.g., logic “0” flag). In the aggregate, then, the control unit 34 may be further configured to produce an output signal indicative of whether a misfire occurred in any of the cylinders, such as for example by way of an internal misfire condition flag 48. Additionally, control unit 34 may be still further configured to generate an output signal identifying the single cylinder that misfired, or what multiple cylinders (e.g., cylinder pair) that misfired, such as by a cylinder identification flag 50. It should be understood that control unit 34 may be configured to produce, alternatively (or in addition to), these flags as externally available electrical signals, and that such signals would fall within the spirit and scope of the present invention.

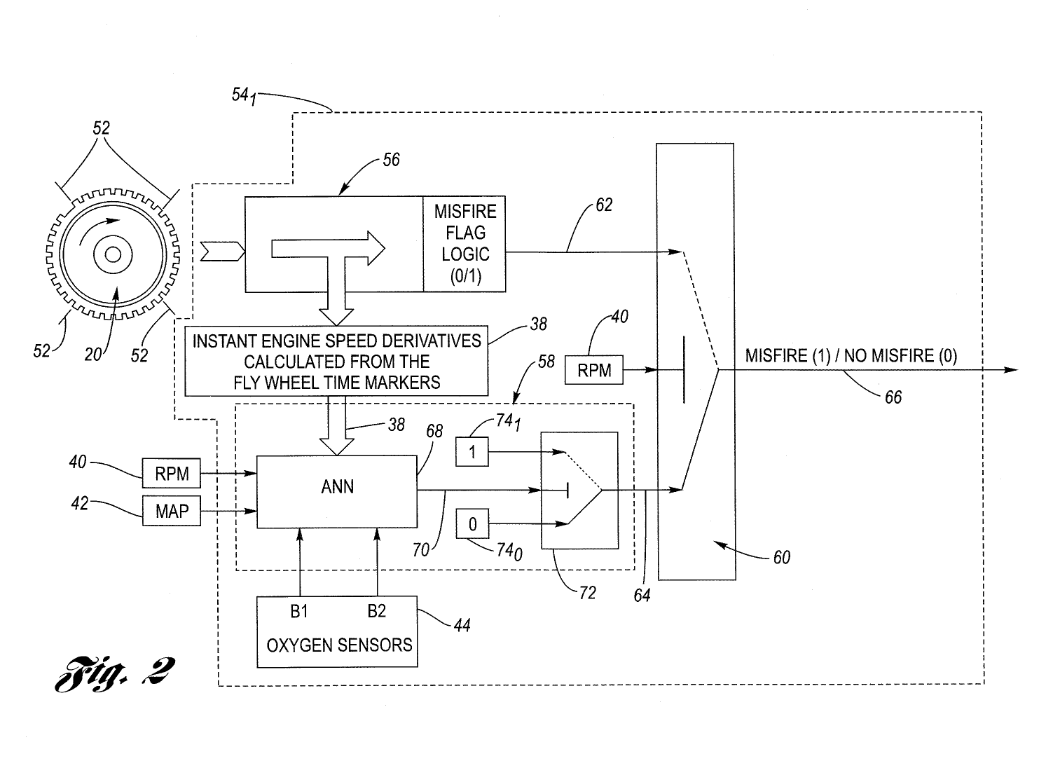

FIG. 2 is a block diagram showing one portion 54₁ of an ANN-enhanced misfire detection system adapted to service a single cylinder of the engine. It should understood, based on the previous description, that additional portions 54ᵢ (where i corresponds to the number of cylinders) are not shown but would be provided in order to implement misfire detection functionality for all of the cylinders of the engine 12. It should be further understood that for purposes of description, the additional portions 54ᵢ may be the same as the portion 54₁ to be described below. Finally, while portion 54₁ is shown in block diagram form in FIG. 2, it need not be either physically separate or even programmed separately, but rather is illustrated in block form for clarity in describing the processing that occurs with respect to a single cylinder.

The portion 54₁ for a single cylinder includes a primary, low-speed misfire detection block 56, an enhancement, high-speed (ANN-based) misfire detection block 58 enclosed in dashed-lines, and an engine-speed controlled selector 60. The low-speed misfire detection block 56 may be configured to operate in accordance with existing art strategies, such as that described in the Background, which seeks to identify when engine speed variations attributable to a cylinder exceed a threshold. The low-speed misfire detection block 56 is, in a preferred embodiment, responsive to engine speed derivatives, as in block 38 of the input vector 36 (FIG. 1), which may be produced as per flywheel time markers 52 or the like. Through this common input data, efficiency in processing is increased (i.e., no need to produce separate data sets for each of the blocks 56, 58). Block 56 is configured to produce an output signal 62 taking on a value of a logic “0” (indicating normal operation) or a logic “1” (indicating a misfire). The high-speed misfire detection block 58 is configured to include an algorithm that emulates multiple ANNs, as described herein. The ANN-based detection block 58 is also responsive to the values of the engine speed derivatives (as in block 38 in FIG. 1) and is configured to produce an output signal 64. The output signal 64 may take on the value of a logic “0” (indicating normal operation) or a logic “1” (indicating a misfire).

The selector 60 is responsive to the instant engine speed 40 (e.g., rpm) to select either signal 62 or signal 64 and generate an overall output signal 66. the overall output signal 66 is indicative of whether the cylinder misfired or not (i.e., taking on a value of a logic “1” if the cylinder misfired or taking on a value of a logic “0” if the cylinder did not misfire). In one embodiment, the selector 60 is configured to select the signal 62 for output as the signal 66 when the engine speed signal 40 is at or below a predetermined, threshold engine speed. The selector 60 is further configured to select the signal 64 for output as the signal 66 when the engine speed 40 exceed the predetermined, threshold engine speed. In one embodiment, the threshold engine speed may be 3500 rpm. However, it should be understood that the particular value in any application will depend on the specifics of that application (e.g., the number of cylinders in the engine, the mechanical characteristics thereof, the performance of the respective detection blocks 56 and 58 in their respective engine speed operating regions, etc.).

The ANN-based misfire detection block 58 includes an ANN-emulated algorithm (“ANN”) 68 having an output 70 and an ANN-output controlled selector 72. The ANN 68 is responsive to the input vector 36, which as described above includes the engine speed derivatives block 38, and optionally the engine speed 40, the engine load 42, and one or more exhaust oxygen sensor output values 44. The ANN 68 is configured, preferably, to provide an output ranging between a zero (“0”) and a one (“1”), with a zero representing normal operation and a one representing a misfire. The selector 72 includes threshold determining logic, such that when the output 70 from the ANN 68 is below a predefined threshold, for example 0.5, it will select a logic “0” from block 740 for output as the output signal 64. Likewise, the selector 72 is further configured such that when the output 70 from the ANN 68 is above the predefined threshold (e.g., 0.5), then it will select a logic “1” from block 74, for output as the output signal 64. It should be understood that the predefined threshold may itself be either inclusive with no misfire, or alternatively with misfire.

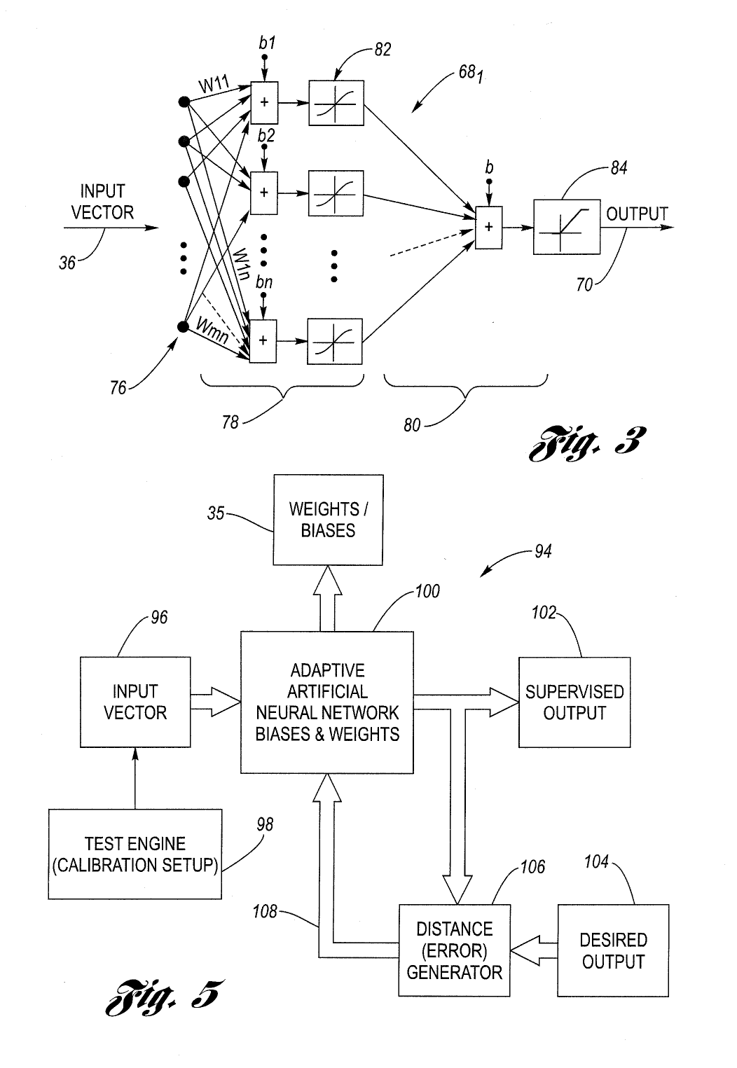

FIG. 3 is a simplified, diagrammatic view of a first embodiment of ANN 68. The ANN architecture, which is designated 681, is configured to serve a single cylinder and includes an input layer 76, a hidden neuron layer 78 and an output neuron/layer 80. The input vector 36, as described above is provided to the input layer 76. The input vector 36 is processed in accordance with the respective weights W11, W12, . . . W1n, W21, W22, . . . W2n, Wm1, . . . . Wmn, where m is the number of inputs in the input vector 36 and n is the number of neural nodes in the hidden neuron layer 78. FIG. 3 also shows the respective biases designated b1, b2, . . . bn.

In addition, the hidden neuron layer 78 is configured to include a sigmoidal (e.g., S-shaped) transfer function 82. The output neuron 80 includes a “satlin” type transfer function 84 having an output 70 (consistent with FIG. 2). The “satlin” transfer function comprises saturated regions (i.e., the horizontal line regions) as well as an intervening linear region. Note, the output “satlin” transfer function 84 limits the output signal 70 to between zero and one, with zero representing normal operation and one representing misfire. This choice conditions the training of the ANN. More specifically, for a fixed number of neural nodes, the outcome of the training process is enhanced by the fact that the neural network's “resources” are not spent to enforce a limited spread of the output to numbers that are lower than zero and larger than one. The predefined threshold level of the ANN-output controlled selector 72, described above as 0.50, is thus set approximately half-way between the two states.

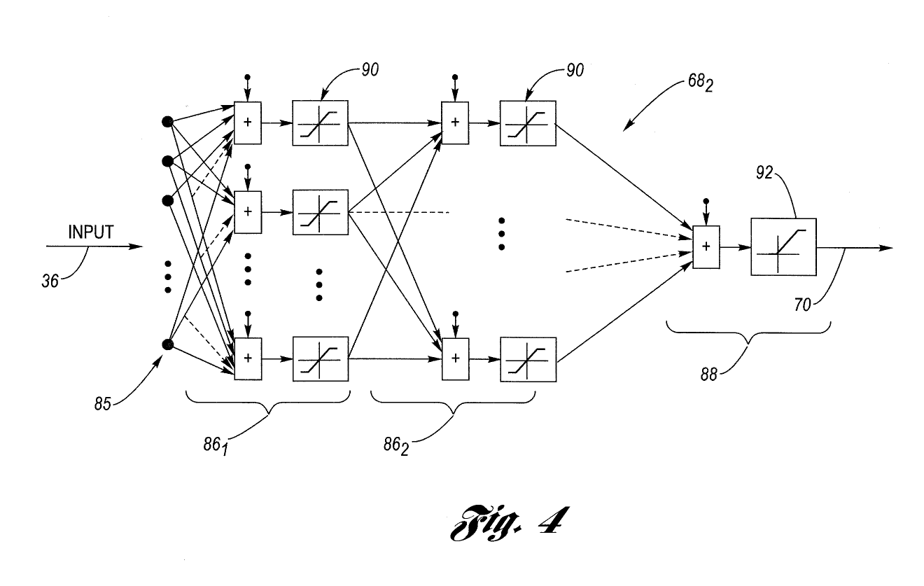

FIG. 4 is a simplified, diagrammatic view of a second embodiment of ANN 68. The ANN architecture, which is designated 682, is configured to serve a single cylinder (just like FIG. 3) and includes an input layer 85, a first hidden neuron layer 861, a second hidden neuron layer 862 and an output neuron/layer 88. This realization of ANN 68 includes two hidden neuron layers each having “satlin” transfer functions 90. The output neuron/layer 88 also features a “satlin” transfer function 92. One advantage of the realization shown in FIG. 4 is that it readily lends itself to efficient computer-implementation, due to, in part, the linear relationship expressed in each of the “satlin” transfer functions 90 and 92 (i.e., the implementation comprises multiplicative and arithmetic operations, as opposed to more complex mathematics involved in evaluation a sigmoid function).

FIG. 5 shows a system 94 for training the various ANN realizations in accordance with the present invention. The system 94 includes a training input vector 96, a test engine (calibration setup) 98, an adaptive ANN (with adjustable weights/biases) 100 producing a supervised output 102, a desired output 104, and a distance (error) generator 106 configured to generate an error signal(s) 108.

The training input vector 96 is typically configured to include values representing a limited range of engine operating conditions (i.e., engine speed and load) within which an existing misfire algorithm does not provide reliable results. The values in the training input vector 96 are acquired either through dynamometer and/or road testing, which are then “played back”, or in other words provided via input vector 96 to the ANN 100. Note, that the particular misfire status of the cylinder (normal firing or misfire) is also stored and used in the training (i.e., this is the “desired” output 104). In this regard, it is known to employ a “kill generator” or the like on certain cylinders when acquiring the data to force a misfire.

The ANN 100 is initially set with preselected weights and biases with the understanding that the training process will cause the weights and biases to converge on a solution that reduces the error 108 to a desired level. It should be understood that each cylinder of any particular engine will have, as described above, its own set of weights and biases. The distance generator 106 is configured to generate an error 108. The adaptive ANN 100 includes a function that is responsive to the error 108 and is configured to find the best combination of weights and biases to try for the next iteration. The art is replete with strategies for training an ANN, including the particular function of determining the next combination of weight and bias values. Once the supervised output 102 meets a desired quality standard, the computational algorithm (including the sets of weight and bias values for the respective cylinders) is “frozen.” The sets of weights and biases are stored in block 35 for use in production embodiments for that specific engine type.

### EXAMPLE

An 8-cylinder engine was tested using the ANN-enhanced misfire detection at engine speeds equal to or greater than 3500 rpm. All eight ANN-based algorithms were trained with input signals representing derivatives of the engine speed that were generated (and used by) the existing misfire detection algorithm, plus an instant engine speed and engine load (e.g., as provided by the conventional operation of an engine controller). The parameters of the input vector were updated only once per combustion cycle. The performance of the existing art algorithm for low-speeds, as enhanced by the ANN-based misfire detection at high speeds is shown in Table 2 below. The range of engine speed/load was limited to those combinations where the existing art misfire detection algorithms had encountered difficulties in reliably/accurately detecting misfire. As shown in Table 2, the discrimination capability provided by the present invention has been dramatically improved.

TABLE 2

| Single cylinder misfire | | | Opposite pairs misfire | | |
|---|---|---|---|---|---|
| MAP | RPM | | MAP | RPM | |
| (load) | (speed) | DMSS | (load) | (speed) | DMSS |
| 30 | 3500 | 5.67 | 35 | 3500 | 2.94 |
| 35 | 4000 | >6 | 40 | 4000 | >6 |
| 50 | 4000 | >6 | 50 | 4000 | >6 |
| 35 | 4500 | >6 | 40 | 4500 | >6 |
| 50 | 4500 | >6 | 50 | 4500 | >6 |
| 40 | 5000 | >6 | 45 | 5000 | >6 |
| 45 | 5500 | >6 | 60 | 5500 | >6 |
| 60 | 6000 | 3.44 | 60 | 6000 | 4.5 |

In accordance with the present invention, the control unit 34 is configured with an ANN-enhanced misfire detection function as further described herein. It should be understood that the functional and other descriptions and accompanying illustrations contained herein will enable one of ordinary skill in the art to practice the inventive misfire detection inventions without undue experimentation. It is contemplated that the invention will preferably be practiced through programmed operation (i.e., execution of software computer programs) of the control unit 34.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A method for misfire detection in a multi-cylinder internal combustion engine system, comprising the steps of:
producing an input vector including a respective engine speed derivative for each cylinder;
providing the input vector to a first artificial neural network (ANN)-based misfire detection block configured to operate in accordance with an ANN, the ANN being associated with a selected one of the cylinders, the first misfire detection block having a first output signal indicative of whether the selected one cylinder has misfired; and
generating, when an engine speed exceeds a predetermined threshold, a misfire signal for the engine system based on the first output signal from the first ANN-based detection block.

2. The method of claim 1 further including the steps of:
providing a second misfire detection block responsive to the engine speed derivatives and which is configured to generate a second output signal indicative of whether the selected one cylinder has misfired; and wherein said generating step further includes:
defining, when the engine speed is equal to or less than the predetermined threshold, the engine system misfire signal by the second output signal.

3. The method of claim 1 wherein the input vector further includes the engine speed and an engine load.

4. The method of claim 3 wherein the input vector further includes an oxygen sensor signal derived from an oxygen sensor disposed in an exhaust gas flow of said selected cylinder.

5. The method of claim 2 further including the step of:
configuring the ANN-based first misfire detection block to operate in accordance with a plurality of distinct ANNs each of which is conditioned by a respective set of weights and biases to correspond to a respective one of the cylinders in the engine system wherein the first misfire detection block includes a plurality of first output signals indicative of whether a respective one of the cylinders has misfired.

6. The method of claim 5 wherein the step of generating the engine system misfire signal further includes the sub-steps of:
outputting, on a cylinder-by-cylinder basis, a respective misfire signal so as to establish a plurality of misfire signals that collectively indicate whether any of the cylinders have misfired and the identity of any such misfiring cylinders.

7. The method of claim 2 wherein at least one of the ANNs is characterized by an input layer, a hidden neuron layer and an output neuron layer, and wherein the at least one ANN has the hidden neuron layer configured to include a sigmoid transfer function.

8. The method of claim 2 wherein at least one of the ANNs is characterized by an input layer, a hidden neuron layer and an output neuron layer, and wherein the at least one ANN has the hidden neuron layer configured to include a satlin transfer function.

9. The method of claim 8 wherein at least one of the ANNs is characterized by an input layer, a hidden neuron layer and an output neuron layer, and wherein the at least one ANN has the output neuron layer configured to include a satlin transfer function.

10. The method of claim 9 wherein the satlin transfer function of the output neuron layer includes an output having a range between a zero and a one.

11. The method of claim 5 further including the step of:
configuring the second misfire detection block to produce a plurality of second output signals indicative of whether a respective one of the cylinders has misfired.
